(19) United States
(12) Patent Application Publication
(10) Pub. No.: US 2004/0168317 A1
(43) Pub. Date: Sep. 2, 2004

(54) Crimping method and unit for joining an electric connector to a flat electric cable

(76) Inventor: Luigi Aluffo, Felizzano (IT)

Correspondence Address: HARRINGTON & SMITH, LLP, 4 RESEARCH DRIVE, SHELTON, CT, 06484-6212, US

(21) Appl. No.: 10/474,530

(22) PCT Filed: Apr. 12, 2002
(86) PCT No.: PCT/EP02/04105

(30) Foreign Application Priority Data
Apr. 13, 2001 (IT) TO2001A000367

(51) Int. Cl. B23P 19/00; H01R 43/042

(52) U.S. Cl. 29/863; 29/753

(57) ABSTRACT

A method of joining an electric connector (2) to a flat electric cable (3) in a crimping unit (1); the connector being defined by an insulating casing (8), a first conducting portion (4) supported by the casing (8), and a cover (9) hinged to the casing (8); and the cable having a strip (6), and a second conducting portion (5) on the strip (6). The method includes inserting the casing (8) in a first seat (32) on the crimping unit (1); inserting the cover (9) in a second seat (41) on the crimping unit (1) to keep the cover (9) in an open position; inserting an end portion (7) of the cable (3) between the casing (8) and the cover (9); and crimping the first and second conducting portion (4, 5) by means of the crimping unit (1).

### TECHNICAL FIELD

The present invention relates to a method of joining an electric connector to a flat electric cable in a crimping unit.

### BACKGROUND ART

Flat electric cables comprise a strip of insulating material on which are arranged longitudinally a number of parallel conducting tracks defining a first conducting portion.

Electric connectors comprise a casing made of insulating material; a second conducting portion supported by the casing; and a cover made of insulating material, associated with the casing, and movable between and open position and a closed position.

To join electric connectors to flat electric cables, the first and second conducting portion are connected mechanically and electrically, i.e. crimped, and the casing is connected mechanically to the flat electric cable.

At present, crimping units capable of effectively joining electric connectors to flat electric cables and permitting a high production output rate with very few rejects do not exist.

### DISCLOSURE OF INVENTION

It is an object of the present invention to provide a crimping method for joining an electric connector to a flat electric cable in a crimping unit, and which, in a straightforward, low-cost manner, permits a high production output rate with no stoppages of the crimping unit.

According to the present invention, there is provided a method of joining an electric connector to a flat electric cable in a crimping unit; said connector comprising an insulating casing, a first conducting portion supported by said casing, and a cover hinged to said casing; said cable comprising a strip, and a second conducting portion on said strip; and the method comprising the steps of:

inserting said casing in a first seat on the crimping unit;

inserting said cover in a second seat on the crimping unit to keep the cover in an open position with respect to said casing;

inserting an end portion of said cable between said casing and said cover; and

crimping said first and said second conducting portion by means of the crimping unit.

The present invention also relates to a crimping unit.

According to the present invention, there is provided a crimping unit for joining an electric connector to a flat electric cable, wherein said connector comprises an insulating casing, a first conducting portion supported by said casing, and a cover hinged to said casing; and said cable comprises a strip, and a second conducting portion on said strip; the crimping unit comprising a pocket partly defining a first seat for housing said casing, a head having a second seat for housing the cover and keeping the cover in an open position with respect to said casing, an anvil assembly, and a pressure assembly for crimping said first and said second conducting portion.

### BRIEF DESCRIPTION OF THE DRAWINGS

A non-limiting embodiment of the present invention will be described by way of example with reference to the accompanying drawings, in which:

FIG. 1 shows a view in perspective, with parts removed for clarity, of a crimping unit in accordance with the present invention for crimping flat electric cables to electric connectors;

FIG. 2 shows a view in perspective, with parts removed for clarity, of an assembly comprising an electric connector and a flat electric cable;

FIG. 2a shows a larger-scale detail of the FIG. 2 connector;

FIG. 3 shows a larger-scale view in perspective of a detail of the FIG. 1 unit;

FIG. 4 shows a plan view of the FIG. 3 detail;

FIG. 5 shows a smaller-scale section along line VV, with parts removed for clarity, of a control device associated with the FIG. 4 detail and in an operating position;

FIG. 6 shows a smaller-scale section, with parts removed for clarity, of the FIG. 5 control device in a rest position;

FIG. 7 shows a larger-scale section, with parts removed for clarity, of the FIG. 4 detail along line VII-VII, with a flat electric cable inserted inside the connector;

FIG. 8 shows a larger-scale section, with parts removed for clarity, of the FIG. 4 detail along line VIII-VIII;

FIG. 9 shows a larger-scale section of a head of the FIG. 1 unit control device;

FIG. 10 shows a larger-scale section along line XX of the FIG. 1 crimping unit.

### BEST MODE FOR CARRYING OUT THE INVENTION

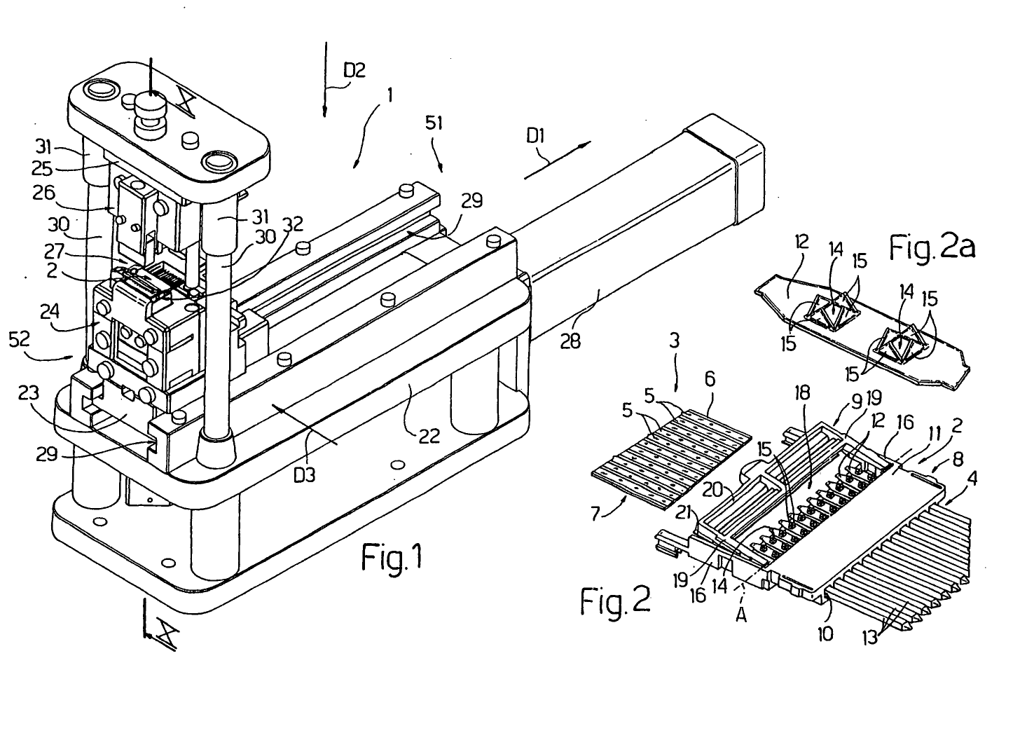

With reference to FIGS. 1 and 2, number 1 indicates as a whole a crimping unit for joining an electric connector 2 to a flat electric cable 3, and connecting electric terminals 4 of connector 2 to respective conducting tracks 5 of cable 3. In other words, connector 2 comprises a conducting portion defined by electric terminals 4, and cable 3 comprises a conducting portion defined by tracks 5. With reference to FIG. 2, each flat electric cable 3 comprises a strip 6 of insulating material supporting a number of parallel conducting tracks 5; each track 5 is located a given distance from the adjacent track 5 so as to be electrically insulated from it; and the number of conducting tracks 5 of each cable 3 varies depending on end-use requirements.

For simplicity, the end portion of cable 3 for connection to relative connector 2 will be referred to hereinafter as “end portion” 7.

Connector 2 comprises a flat insulating casing 8, and a cover 9 hinged to casing 8. Casing 8 comprises a main body 10, in which is formed a row of parallel cavities 11 for housing a number of electric terminals 4 equal to the number of conducting tracks 5 on relative cable 3. Each electric terminal 4 comprises a connecting blade 12 which is crimped to a relative conducting track 5 on cable 3; and a connecting pin 13 which is inserted inside a complementary terminal (not shown). Though male terminals 4 are shown in FIG. 2, the same characteristics also apply to female terminals (not shown), which differ from terminals 4 by having seats in place of pins 13.

As shown more clearly in FIGS. 2a and 8, each blade 12 has two holes 14, each of which is surrounded by pointed tabs 15 extending perpendicularly to blade 12 and formed by cross-cutting blade 12 and then bending the tabs squarely with respect to blade 12. The bent tabs 15 are substantially triangular, provide for piercing strip 6 and track 5, and are folded onto end portion 7 and outwards of hole 14 to connect blade 12 and a respective track 5 electrically and mechanically.

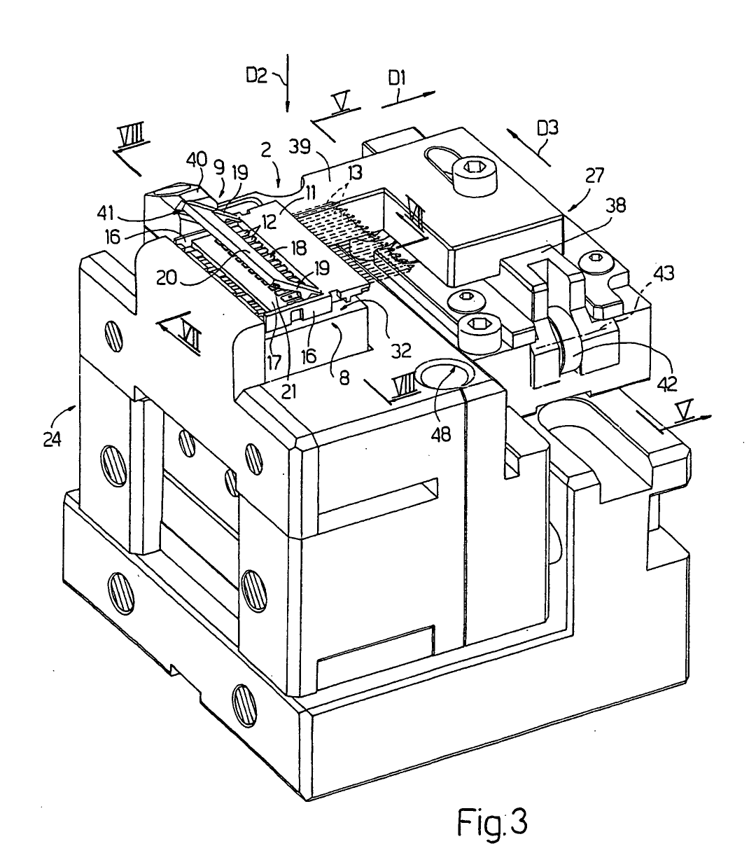

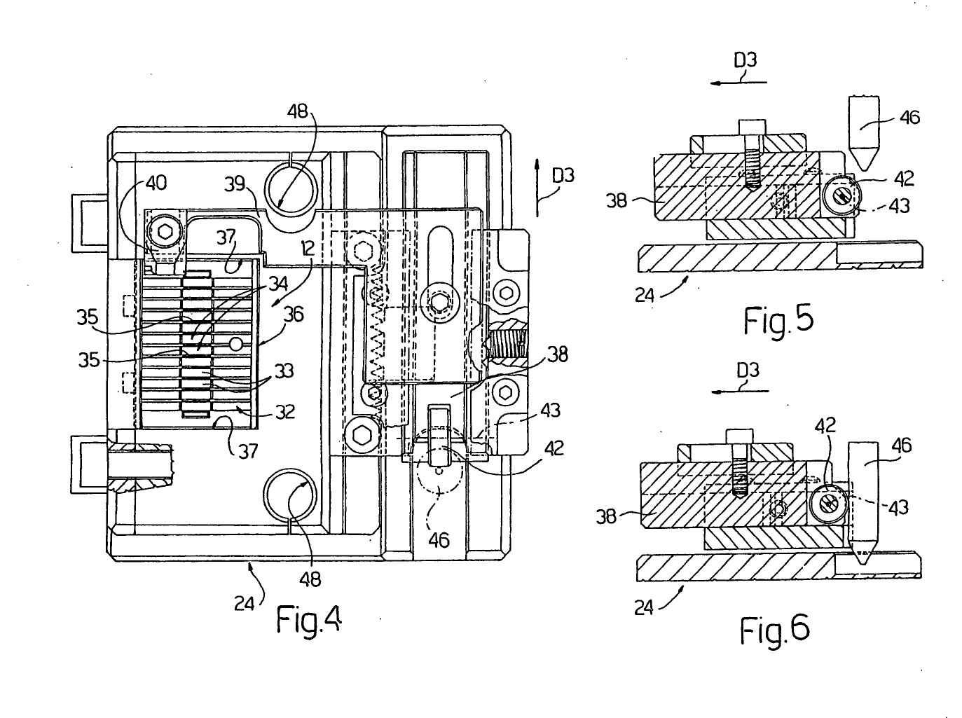

As shown more clearly in FIG. 3, casing 8 has two lateral arms 16 extending from main body 10; and a crosspiece 17 connecting arms 16 to form a window 18 partly occupied by blades 12.

Cover 9 is substantially C-shaped, is hinged to arms 16 about an axis A perpendicular to arms 16, and comprises two levers 19 parallel to arms 16 and supporting a crosspiece 20 parallel to crosspiece 17. Levers 19 have two projections 21, which fit inside respective seats (not shown) on arms 16 to click cover 9 shut with respect to casing 8 in a position (not shown) in which crosspieces 17 and 20 grip cable 3.

In the open position shown in FIG. 3, cover 9 slopes with respect to arms 16, so that end portion 7 of cable 3 can be inserted between crosspieces 17 and 20 to position conducting tracks 5 directly on top of respective blades 12.

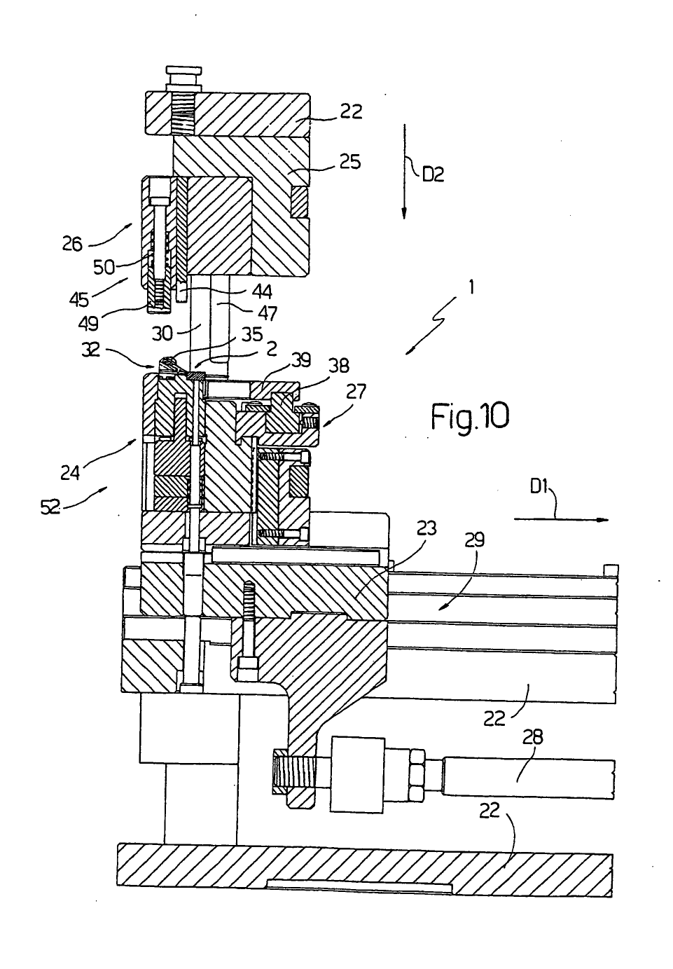

With reference to FIGS. 1 and 10, crimping unit 1 comprises a frame 22; a slide 23 movable with respect to frame 22 in a horizontal direction D1; an anvil assembly 24 on slide 23; a slide 25 movable in a vertical direction D2; a pressure assembly 26 fitted to slide 25 and which cooperates with anvil assembly 24; a control device 27 for controlling the position of cover 9: a drive member 28 for moving slide 23 back and forth in direction D1; and a drive member (not shown) for moving slide 25 up and down in direction D2. Frame 22 comprises two horizontal grooves 29, which are engaged prismatically by slide 23 to guide slide 23 in direction D1; and two vertical columns 30, each of which engages a sleeve 31 of slide 25 to guide slide 25 in direction D2. Anvil assembly 24 is fitted to the top of slide 23, and has a seat 32 for housing connector 2; and device 27 is fitted to anvil assembly 24.

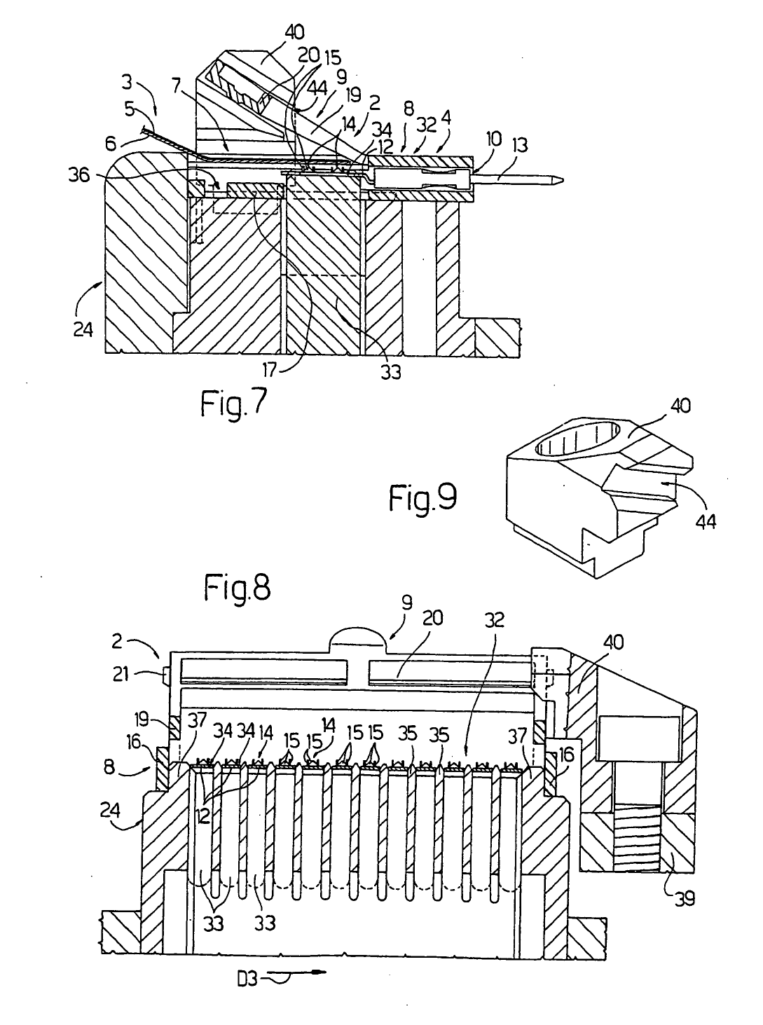

With reference to FIGS. 7 and 8, anvil assembly 24 comprises an anvil 33 defining seat 32 and having a number of surfaces 34 for supporting blades 12 and separated by partitions 35; and an annular pocket 36 extending about anvil 33 and for housing casing 8. More specifically, pocket 36 comprises two walls 37 for centering window 18, and which contact arms 16.

With reference to FIG. 3, device 27 is fitted to anvil assembly 24, and is movable, with respect to anvil assembly 24, in a horizontal direction D3 perpendicular to direction D1. Device 27 comprises a central body 38; and an arm 39 projecting, parallel to direction D1, from body 38 and having, on its free end, a head 40 with a seat 41 for housing a lever 19 of cover 9. Body 38 is fitted prismatically to anvil assembly 24, and is movable between an operating position (FIGS. 3 and 8) in which head 40 extends over a wall 37 of pocket 36, so that cover 9 can engage seat 41 when casing 8 is inserted inside pocket 36, and a rest position (FIG. 6) in which head 40 is moved laterally away from wall 37 of pocket 36 to load connector 2 onto anvil assembly 24 and click cover 9 onto casing 8.

With reference to FIG. 3, device 27 comprises a roller 42 fitted to body 38 and which rotates about an axis 43 parallel to direction D1.

Pressure assembly 26 comprises a member 44 for deforming tabs 15; a pusher 45 for closing cover 9 with respect to casing 8; a vertical rod 46 having a tapered free end, and which cooperates with roller 42 to move device 27 and head 40 from the operating to the rest position; and two vertical rods 47 which engage two guide holes 48 formed in anvil assembly 24. Pusher 45 comprises a head 49, which is positioned along crosspiece 20, is connected prismatically to pressure assembly 26 to slide in direction D2, and is kept in the down position by a spring 50.

In actual use, and with reference to FIG. 1, anvil assembly 24 is positioned at the rear end of frame 22, at a loading station 51 outside the working area of pressure assembly 26, to facilitate insertion of connector 2 inside seat 32, and cover 9 inside seat 41.

More specifically, at this stage, device 27 is set to the rest position so as not to interfere with the loading of connector 2, and, once connector 2 is inserted inside seat 32, is moved to the operating position to receive cover 9 inside seat 41.

Anvil assembly 24 is then moved back by drive member 28 to the FIG. 1 position, i.e. to a crimping station 52, where anvil assembly 24 is aligned beneath pressure assembly 26. As shown in FIGS. 3, 7 and 8, connector 2 is positioned inside seat 32 with cover 9 raised and partly engaging seat 41 of head 40 of device 27. At crimping station 52, end portion 7 of cable 3 is inserted inside seat 32, on top of blades 12 and between crosspieces 17 and 20, and pressure assembly 26 is lowered in direction D2 along columns 30 towards anvil assembly 24. As pressure assembly 26 moves towards anvil assembly 24, the following operations are performed successively: vertical rods 47 engage holes 48 in anvil assembly 24; rod 46 interacts with roller 42 to push device 27 into the rest position (FIG. 6) and free cover 9; pusher 45 intercepts crosspiece 20 of cover 9 and pushes cover 9 into the closed position in which projections 21 engage the respective seats (not shown) in arms 16 to click cover 9 onto casing 8; member 44 intercepts and pushes end portion 7 of strip 6 against pointed tabs 15 of blades 12 resting on anvil 33, so that pointed tabs 15 pierce strip 6 and tracks 5; and member 44 presses tabs 15 against anvil 33 to fold tabs 15 outwards of respective holes 14. When crimping blades 12 to tracks 5, head 49 of pusher 45 overcomes spring 50 and moves in the opposite direction to that of pressure assembly 26; and, once crimping is completed, pressure assembly 26 is raised, connector 2 connected to cable 3 is removed from seat 32, and unit 1 is ready to repeat the same cycle.

In a variation not shown, the flat electric cable comprises two opposite, facing strips enclosing a number of parallel conducting tracks located a given distance apart. Such flat electric cables, however, in no way affect crimping unit 1 or the crimping method.

1) A method of joining an electric connector to a flat electric cable in a crimping unit (1); said connector (2) comprising an insulating casing (8), a first conducting portion (4) supported by said casing (8), and a cover (9) hinged to said casing (8); said cable (3) comprising a strip (6), and a second conducting portion (5) on said strip (6); and the method comprising the steps of:
inserting said casing (8) in a first seat (32) on the crimping unit (1);
inserting said cover (9) in a second seat on the crimping unit (1) to keep the cover (9) in an open position with respect to said casing (8);
inserting an end portion (7) of said cable (3) between said casing (8) and said cover (9); and
crimping said first and said second conducting portion (4, 5) by means of the crimping unit (1).

2) A method as claimed in claim 1, and comprising the step of extracting said cover (9) from said second seat (41) by means of a control device (27) of said crimping unit (1) before crimping said first and said second conducting portion (4, 5).

3) A method as claimed in claim 2, and comprising the steps of setting said cover (9) to a closed position with respect to said casing (8); locking said cover (9) to the relative said casing (8); and gripping said cable (3) in a given position between said cover (9) and said casing (8) before crimping said first and said second conducting portion (4,5).

4) A method as claimed in any one of claims 1 to 3, wherein the crimping unit (1) comprises an anvil assembly (24) and a pressure assembly (26); the method comprising the steps of:
moving said anvil assembly (24) in a first direction (D1) between a loading station (51) and a crimping station (52); and
aligning said anvil assembly (24) with said pressure assembly (26), in a second direction (D2) perpendicular to said first direction (D1), at said crimping station (52).

5) A method as claimed in claim 4, and comprising the step of loading said connector (2) onto said anvil assembly (24) at said loading station (51); said first and said second seat (32, 41) being defined respectively by a pocket (36) and a head (40), both on said anvil assembly (24).

6) A method as claimed in claim 4 or 5, wherein the step of inserting said cable (3) between said cover (9) and said casing (8) is performed at said crimping station (52).

7) A method as claimed in claim 5, and comprising the step of moving said head (40) into a rest position in which said cover (9) is released from said second seat (41) as said pressure assembly (26) is lowered in said second direction (D2).

8) A crimping unit (1) for joining an electric connector (2) to a flat electric cable (3), wherein said connector (2) comprises an insulating casing (8), a first conducting portion (4) supported by said casing (8), and a cover (9) hinged to said casing (8); and said cable (3) comprises a strip (6), and a second conducting portion (5) on said strip (6); the crimping unit (1) comprising a pocket (36) partly defining a first seat (32) for housing said casing (8), a head (40) having a second seat (41) for housing the cover (9) and keeping the cover (9) in an open position with respect to said casing (8), an anvil assembly (24), and a pressure assembly (26) for crimping said first and said second conducting portion (4, 5).

9) A unit as claimed in claim 8, and comprising a control device (27) having said head (40); the control device (27) being supported by said anvil assembly (24), and being movable, with respect to the anvil assembly (24), between an operating position wherein said cover (9) engages said second seat (41), and a rest position wherein said cover (9) is extracted from said second seat (41).

10) A unit as claimed in claim 9, wherein said pressure assembly (26) has a first member (46) cooperating with said control device (27) to move said control device (27) and the relative said head (40) between said operating and rest positions.

11) A unit as claimed in one of claims 8 to 10, and comprising a frame (22); said anvil assembly (24) being movable, with respect to said frame (22), between a loading station (51) for loading said connector (2), and a crimping station (52) where said anvil assembly (24) is aligned with said pressure assembly (26) in a second direction (D2).

12) A unit as claimed in claim 11, wherein said pressure assembly (26) is movable in said second direction (D2).

13) A unit as claimed in any one of claims 1 to 12, wherein said pressure assembly (26) comprises a pusher (45) for closing said cover (9) with respect to said casing (8).

14) A unit as claimed in claim 13, wherein said pusher (45) comprises a pusher head (49), which is brought into contact with said cover (9) to close said cover (9); said pusher head (49) being movable in said second direction (D2) with respect to said pressure assembly (26).

15) A unit as claimed in claim 8, wherein said first seat (32) is defined by said pocket (36) and by an anvil (33) for supporting said first conducting portion (4); said pocket (36) surrounding said anvil (33).

16) A unit as claimed in claim 15, wherein said pressure assembly (26) comprises a second member (44) for deforming said first conducting portion (4) and piercing said second conducting portion (5) by gripping them between said second member (44) and said anvil (33).
